(19) United States
(12) Patent Application Publication
(10) Pub. No.: US 2004/0238525 A1
(43) Pub. Date: Dec. 2, 2004

(54) Ceramic cooking system comprising a glass ceramic plate an insulation layer and heating elements

(76) Inventors: Karsten Wermbter, Budenheim (DE); Holger Kobrich, Florsheim (DE)

Correspondence Address: Pauley Petersen & Erickson, Suite 365, 2800 West Higgins Road, Hoffman Estates, IL, 60195, US

(21) Appl. No.: 10/469,897

(22) PCT Filed: Feb. 27, 2002
(86) PCT No.: PCT/EP02/02060

(30) Foreign Application Priority Data
Jun. 3, 2001 (DE) 10110792.7

(51) Int. Cl. H05B 3/68

(52) U.S. Cl. 219/466.1

(57) ABSTRACT

A ceramic cooking system including a glass ceramic plate, with an underside that supports an electrical insulation layer having one or more heating elements for directly heating the glass ceramic plate. This invention improves the adhesion of the insulation during heating and prevents the insulation from partially detaching. Thus, the insulation layer is subdivided into several insulation segments that extend over the cooking area and support heating elements specifically assigned to each segment.

### BACKGROUND OF THE INVENTION

1. Field of the Invention

This invention relates to a ceramic cooking system having a glass-ceramic plate, which has an electrical insulating layer with one or several heating elements for direct heating of the glass-ceramic plate on an underside, wherein the insulating layer is divided into several insulating segments, which extend over the cooking zone and support heating elements for individual segments.

2. Discussion of Related Art

A ceramic cooking system of this type is known from Great Britain Patent Reference GB-A-2 288 110. There, heating elements are arranged in a ray shape and connected in parallel, so that they can only be switched on or off together.

As a rule, ceramic cooking systems include a level glass-ceramic plate, on whose top the cooking utensil to be heated is placed. The glass-ceramic plates have oxidic and non-oxidic ceramic materials, as disclosed in PCT International Publication WO 00/15005, French Patent Reference FR 2 744 116, European Patent Reference 0 861 014 A1 and U.S. Pat. No. 6,037,572.

For electrical insulation, an insulating layer is applied between the glass-ceramic plate and the heating elements for electrical insulation. Materials with high electrical insulation values are suitable as materials for this insulating layer, in particular material systems AL₂O₃—SiO₂—M_{g}O with materials such as corundum, mullite, periclase, spinel and cordierite.

The heating elements are applied to the insulating layer. Thin layers provided over the entire surface by sputtering or by CVD processes can be used as insulating layers, wherein SₙO₂ in particular is used, as indicated in PCT International Publication WO 00/18189.

A further possibility is the application of thick film strip conductors made of silver-palladium alloys by screen printing processes, as shown in European Patent References EP 0 861 014 A1 and EP 0 069 218 A1.

The application of the insulating layer to the underside of the glass-ceramic plate presents difficulties in connection with such cooking systems, because it must not only adhere very strongly to the glass-ceramic plate, but must also have a high electrical insulating effect along with good heat conduction. As a rule, this requires a not totally satisfactory compromise.

Insulating layers, which are made of AL₂O₃, spinel, ZrO₂ or MgO applied as thick films and have a high degree of insulating effects, are known for a ceramic cooking system. Because they have a substantially greater expansion coefficient than glass-ceramic plates, great stresses result in the insulating layer particularly during heating, which can lead to a partial loosening of the adhesion to the glass-ceramic plate.

If materials which adhere better to the glass-ceramic plate and have lower expansion coefficients, such as mullite or cordierite, are used for the insulating layer, it is necessary for insulation purposes to apply a thicker layer, which then results in a loss of heat transfer.

### SUMMARY OF THE INVENTION

It is one object of this invention to provide a ceramic cooking system of the type mentioned above but which is of simple construction, and still has the detection of the temperature in individual partial zones and an individual regulation and wiring of the heating elements.

In accordance with the invention this object is attained with sensor tracks for temperature measurement that are applied to the places free of insulating layers on the underside of the glass-ceramic plate.

This construction of the cooking system with a glass-ceramic plate, insulating layer and heating elements permits the individual regulation and wiring of the heating elements without negatively affecting the mechanical properties. With the division of the insulating layer into several insulating segments, such as the division of the cooking zone into several partial zones, insulating areas of small surfaces are created. The dimensions of the assigned insulating segments are such that no high mechanical stresses can form in them, which might lead to the partial separation from the underside of the glass-ceramic plate during heating. This allows the use of materials with high insulation effects and good heat transfer, which can be applied as thick films without the danger of errors occurring. Thus, in an advantageous manner, the insulating segments of AL₂O₃, mullite or cordierite, ZrO₂ are applied as a layer of a thickness of 100 to 400 μm.

Because the insulating segments are at least partially connected with each other via insulation bridges for the connecting strip conductors, the heating elements of the individual segments applied to the insulating elements can be wired in the desired way. Thus it is possible to perform temperature measurements in individual sectors with the sensor tracks applied to the places free of insulation of the ceramic plate.

Different patterns can be used for the division of the insulating layer. Thus, the division of the insulating layer is performed in the form of insulating segments in the shape of sectors of a circle, which are arranged concentrically with respect to each other.

A particularly advantageous division can be made so that the division of the insulating layer into an approximately disk-shaped center insulation segment with a sector-shaped recess for connecting lines, and several insulating segments in the shape of sectors of a circle which enclose the disk-shaped insulating segment is performed.

In certain instances a temperature measurement performed centrally in the cooking zone can be of advantage. Thus the design is such that the disk-shaped insulation segment in the center has a cutout for attaching a sensor track.

In accordance with one embodiment, for connecting the heating elements applied individually to the segments the heating elements for the individual segments are applied in the form of electrically conducting strip conductors, and are connected with each other in a desired electrically conducting way via connecting strip conductors embodied as thick film strip conductors.

The heating elements need not only be embodied as thick film heat conductors, but also as full surface heating foils matched to the size and shape of the insulating segments.

### BRIEF DESCRIPTION OF THE DRAWINGS

This invention is explained in greater detail in view of an exemplary embodiment represented in the drawings, wherein:

FIG. 1 is a plan view of an underside of a glass-ceramic plate section with a divided insulating layer; and

FIG. 2 is a plan view of the glass-ceramic plate section in FIG. 1, wherein the insulating segments formed as thick film strip conductors have heating elements for the individual segments.

### DESCRIPTION OF PREFERRED EMBODIMENTS

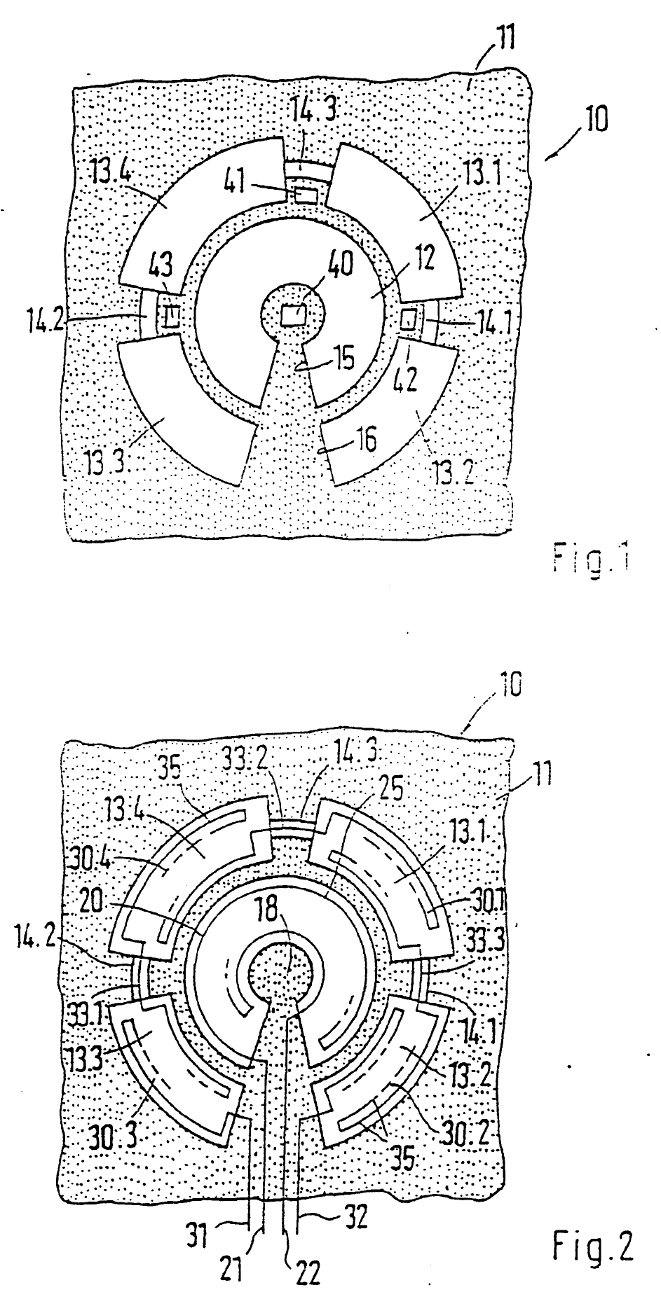

As shown in FIG. 1, a divided insulating layer is assigned in a congruent manner to an underside 11 of each of the cooking zones provided on the glass-ceramic plate 10 marked on its top. In the embodiment represented, the division provides a center, approximately disk-shaped insulating segment 12, which has a free radial sector 15 extending from a center cutout 18 as shown in FIG. 2. Four insulating segments 13.1, 13.2, 13.3 and 13.4 are distributed spaced around this center insulating segment 12, wherein another sector 16 remains free between the insulating segments 13.2 and 13.3. The sector 16 extends the sector 15 and offers access for the electrical connection of the heating elements. The insulating segments 13.1 and 13.2 are connected with each other by an insulation bridge 14.1. The insulation bridge 14.2 connects the insulating segments 13.3 and 13.4, while the insulation bridge 14.3 connects the insulating segments 13.4 and 13.1 with each other.

The areas free of insulating layers between the insulating segments 12, 13.1, 13.2, 13.3 and 13.4 can support sensor tracks 40, 41 and 42 for temperature measurements, by which the temperatures in the individual partial zones can be detected in order to be able to individually switch and regulate the heating elements of the partial zones.

Heating elements 20, 30.1, 30.2, 30.3 and 30.4 for the individual segments are applied to the insulating segments 12, 13.1, 13.2, 13.3 and 13.4, as shown in FIG. 2. In this case the heating elements are also formed by thick film strip conductors 25 or 35, which are arranged concentrically with respect to each other, have the shape of sectors of a circle and are switched in series in a meander shape.

The connecting lines 21 and 22 are actuated while providing current for the heating element 20 attached to the center insulating segment 20.

The heating elements 30.1, 30.2, 30.3 and 30.4 on the insulating segments 13.1, 13.2, 13.3 and 13.4 are switched in series, one behind the other, wherein the connecting thick film strip conductors 33.1, 33.2 and 33.3 on the insulation bridges 14.1, 14.2 and 14.3 complete the series connection.

The series-connected heating elements 30.1, 30.2, 30.3 and 30.4 are controlled by and have current via connecting lines 31 and 32.

Thus the insulating segments 12, 13.1, 13.2, 13.3 and 13.4 can be kept small, so that during heating substantially lesser mechanical stresses occur than with an insulating layer covering the entire cooking zone. It is thus possible to use materials for the insulating segments which have a higher expansion coefficient, but also increased insulating effects and, in the form of a thin layer, have more advantageous heat transfer properties.

1. A ceramic cooking system having a glass-ceramic plate having an electrical insulating layer with one or several heating elements (20, 30.1, 30.2, 30.3, 30.4) for direct heating of the glass-ceramic plate (10) on an underside, wherein the insulating layer is divided into several insulating segments (12, 13.1, 13.2, 13.3, 13.4) which extend over a cooking zone and support the heating elements (20, 30.1, 30.2, 30.3, 30.4) for the individual segments, the ceramic cooking system comprising:
sensor tracks (40, 41, 42, 43) for temperature measurement applied to insulation-free places of the underside (11) of the glass-ceramic plate (10).

2. In the cooking system in accordance with claim 1, wherein the insulating segments (12, 13.1, 13.2, 13.3, 13.4) are at least partially connected with each other via insulation bridges (14.1, 14.2, 14.3) for connecting strip conductors (33.1, 33.2, 33.3).

3. In the cooking system in accordance with claim 2, wherein a division of the insulating layer is has insulating segments each in a form of a sector of a circle, which are arranged concentrically with respect to each other.

4. In the cooking system in accordance with claim 2, wherein the insulating layer is divided into an approximately disk-shaped center insulation segment (20) with a sector-shaped recess (15) for connecting lines, and the insulating segments (13.1, 13.2, 13.3, 13.4) each in a shape of the sector of the circle which enclose the disk-shaped insulating segment (12).

5. In the cooking system in accordance with claim 4, wherein the disk-shaped insulation segment (12) in a center has a cutout (17) for attaching a sensor track (40).

6. In the cooking system in accordance with claim 5, wherein the insulating segments (12, 13.1, 13.2, 13.3, 13.4) are applied as a thick film of at least one of an AL₂O₃ and a mullite and a cordierite, and a ZrO₂ of a thickness of 100 to 400 μm.

7. In the cooking system in accordance with claim 6, wherein the heating elements (20, 30.1, 30.2, 30.3, 30.4) of the individual segments are applied as electrically conductive thick film strip conductors (25, 35), and are connected with each other in an electrically conducting manner by connecting strip conductors (33.1,33.2,33.3) embodied as thick film strip conductors.

8. In the cooking system in accordance with claim 1, wherein a division of the insulating layer has insulating segments each in a form of a sector of a circle, which are arranged concentrically with respect to each other.

9. In the cooking system in accordance with claim 1, wherein the insulating layer is divided into an approximately disk-shaped center insulation segment (20) with a sector-shaped recess (15) for connecting lines, and the insulating segments (13.1, 13.2, 13.3, 13.4) each in a shape of the sector of the circle which enclose the disk-shaped insulating segment (12).

10. In the cooking system in accordance with claim 9, wherein the disk-shaped insulation segment (12) in a center has a cutout (17) for attaching a sensor track (40).

11. In the cooking system in accordance with claim 1, wherein the insulating segments (12, 13.1, 13.2, 13.3, 13.4) are applied as a thick film of at least one of an AL₂O₃ and a mullite and a cordierite, and a ZrO₂ of a thickness of 100 to 400 μm.

12. In the cooking system in accordance with claim 1, wherein the heating elements (20, 30.1, 30.2, 30.3, 30.4) of the individual segments are applied as electrically conductive thick film strip conductors (25, 35), and are connected with each other in an electrically conducting manner by connecting strip conductors (33.1, 33.2, 33.3) embodied as thick film strip conductors.
